(19) United States
(12) Patent Application Publication
(10) Pub. No.: US 2013/0085757 A1
(43) Pub. Date: Apr. 4, 2013

(54) APPARATUS AND METHOD FOR SPEECH RECOGNITION

(71) Applicants: Masanobu NAKAMURA, Tokyo (JP); Akinori KAWAMURA, Tokyo (JP)

(72) Inventors: Masanobu NAKAMURA, Tokyo (JP); Akinori KAWAMURA, Tokyo (JP)

(73) Assignee: Kabushiki Kaisha Toshiba, Tokyo (JP)

(21) Appl. No.: 13/537,740

(22) Filed: Jun. 29, 2012

(30) Foreign Application Priority Data
Sep. 30, 2011 (JP) 2011-218679

(51) Int. Cl. G10L 15/04

(52) U.S. Cl. 704/254; 704/E15.005

(57) ABSTRACT

An embodiment of an apparatus for speech recognition includes a plurality of trigger detection units, each of which is configured to detect a start trigger for recognizing a command utterance for controlling a device, a selection unit, utilizing a signal from one or more sensors embedded on the device, configured to select a selected trigger detection unit among the trigger detection units, the selected trigger detection unit being appropriate to a usage environment of the device, and a recognition unit configured to recognize the command utterance when the start trigger is detected by the selected trigger detection unit.

### CROSS-REFERENCE TO RELATED APPLICATION

This application is based upon and claims the benefit of priority from Japanese Patent Application No. 2011-218679 filed on Sep. 30, 2011, the entire contents of which are incorporated herein by reference.

### FIELD

Embodiments described herein relate generally to an apparatus and a method for speech recognition.

### BACKGROUND

Recently, a speech recognition apparatus that recognizes a command utterance from a user and controls a device has been commercially realized. In order to activate the recognition process of the speech recognition apparatus, various start triggers such as key word utterance, gesture and handclaps are proposed. The speech recognition apparatus starts to recognize the command utterance after detecting the start trigger.

Each start trigger has both merits and demerits based on the usage environment of the device. The detecting performance of the start trigger was deteriorated when the start trigger was not appropriate to the usage environment. For example, it is hard to detect the start trigger by gesture (gesture-trigger) in a dark environment because image recognition performance is deteriorated in such environment. Moreover, it is hard for the user to select an appropriate start trigger for the usage environment even when multiple start triggers are supported in the speech recognition apparatus.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a block diagram of an apparatus for speech recognition according to a first embodiment.

FIG. 2 is a system diagram of a hardware component of the apparatus.

FIG. 3 is a system diagram of a flow chart illustrating processing of a handclap-trigger detection unit.

FIG. 4 is a figure illustrating handclaps detected by the handclap-trigger detection unit.

FIG. 5 is a system diagram of a flow chart illustrating processing of the apparatus for speech recognition.

FIG. 6 is a system diagram of a flow chart illustrating processing of a selection unit according to the first embodiment.

FIG. 7 is a system diagram of a flow chart illustrating processing of a selection unit according to a first variation.

FIG. 8 is an image on a television screen.

FIG. 9 is an image on a television screen.

### DETAILED DESCRIPTION

According to one embodiment, an apparatus for speech recognition comprises a voice-trigger detection unit, a gesture-trigger detection unit, a handclap-trigger detection unit, a selection unit and a recognition unit. The voice-trigger detection unit detects a voice-trigger from a sound obtained by a microphone. The gesture-trigger detection unit detects a gesture-trigger from an image obtained by a camera. The handclap-trigger detection unit detects a handclap-trigger from the sound obtained by the microphone. The selection unit selects and activates a selected trigger detection unit. The selected trigger detection unit is an appropriate trigger detection unit for the usage environment of the television. The trigger detection unit is selected from among the voice-trigger detection unit, the gesture-trigger detection unit and the handclap-trigger detection unit. The selection unit selects the selected trigger detection unit based on signals from a sound sensor which measures a sound volume of the usage environment, a distance sensor which measures a distance from the television to the user and a light sensor which measures an amount of light in the usage environment. The recognition unit starts to recognize the command utterance by the user when the start trigger is detected by the selected trigger detection unit.

Various embodiments will be described hereinafter with reference to the accompanying drawings, wherein the same reference numeral designations represent the same or corresponding parts throughout the several views.

### The First Embodiment

In the first embodiment, an apparatus for speech recognition recognizes a command utterance from a user and controls a device. The apparatus is embedded in a television. The user can control the television such as channel switching or searching the content of TV program listing by the command utterance.

The apparatus according to this embodiment does not need an operation such as a button push when the user gives a start trigger of speech recognition to the television. The apparatus selects a start trigger which is appropriate to the usage environment of the television among gesture-trigger, voice-trigger and handclap trigger. Here, the gesture-trigger is a start trigger by a predefined gesture by the user, the voice-trigger is a start trigger by a predefined keyword utterance by the user and the handclap-trigger is a start trigger by a handclap or claps by the user.

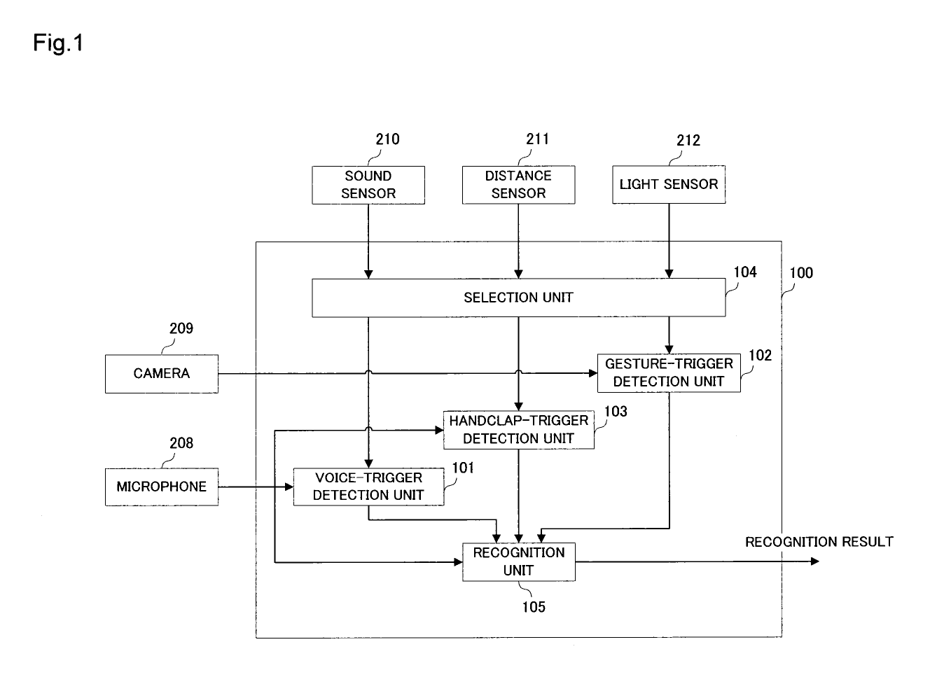

FIG. 1 is a block diagram of an apparatus 100 for speech recognition. The apparatus 100 of FIG. 1 comprises a voice-trigger detection unit 101, a gesture-trigger detection unit 102, a handclap-trigger detection unit 103, a selection unit 104 and a recognition unit 105.

The voice-trigger detection unit 101 detects a voice-trigger from a sound obtained by a microphone 208. The gesture-trigger detection unit 102 detects a gesture-trigger from an image obtained by a camera 209. The handclap-trigger detection unit detects a handclap-trigger from the sound obtained by the microphone 208. The selection unit 104 selects and activates a selected trigger detection unit. The selected trigger detection unit is an appropriate trigger detection unit for the usage environment of the television. The appropriate unit is selected from among the voice-trigger detection unit 101, the gesture-trigger detection unit 102 and the handclap-trigger detection unit 103. The selection unit 104 selects the selected trigger detection unit based on signals from a sound sensor 210 which measures a sound volume of the usage environment, a distance sensor 211 which measures a distance from the television to the user and a light sensor 212 which measures an amount of light in the usage environment. The recognition unit 105 starts to recognize the command utterance by the user when the start trigger is detected by the selected trigger detection unit.

In this way, the apparatus according to this embodiment selects an appropriate trigger detection unit for the usage environment of the television by utilizing a signal from one or more sensors embedded on the television. Accordingly, the apparatus can detect a start trigger with high accuracy, and results in improving recognition performance of the command utterance by the user.

(Hardware Component)

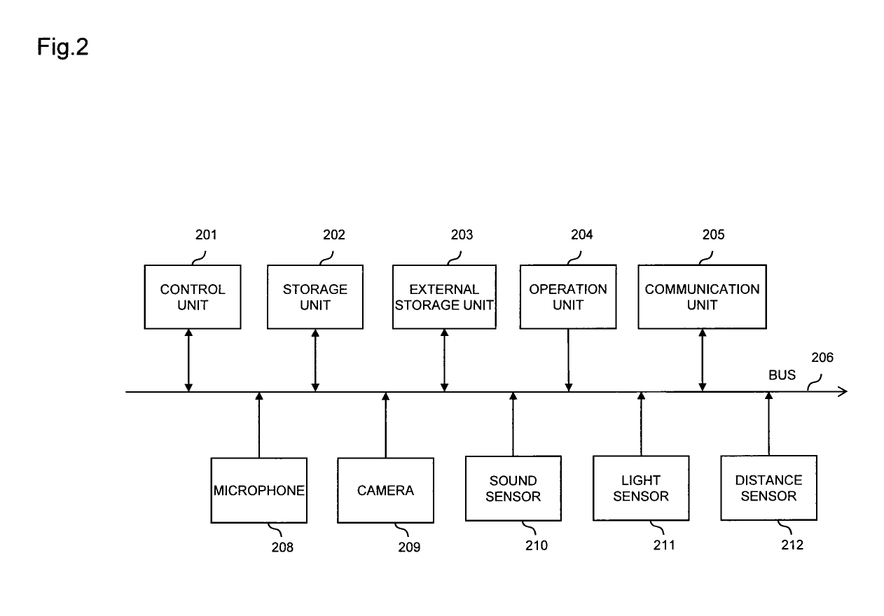

The apparatus 100 is composed of hardware using a regular computer shown in FIG. 2. This hardware comprises a control unit 201 such as a CPU (Central Processing Unit) to control the entire apparatus, a storage unit 202 such as a ROM (Read Only Memory) or a RAM (Random Access Memory) to store various kinds of data and programs, an external storage unit 203 such as a HDD (Hard Access Memory) or a CD (Compact Disk) to store various kinds of data and programs, an operation unit 204 such as a keyboard, a mouse or a touch screen to accept a user's indication, a communication unit 205 to control communication with an external apparatus, the microphone 208 to input a sound, the camera 209 to take an image, the sound sensor 210 to measure a sound volume, the distance sensor 211 to measure a distance from the television, the light sensor 212 to measure an amount of light and a bus 206 to connect the hardware elements.

In such hardware, the control unit 201 executes various programs stored in the storage unit 202 (such as the ROM) or the external storage unit 203. As a result, the following functions are realized.

(The Selection Unit)

The selection unit 104 selects and activates a selected trigger detection unit. The selected trigger detection unit is an appropriate trigger detection unit for the usage environment of the television. The appropriate unit is selected from among the voice-trigger detection unit 101, the gesture-trigger detection unit 102 and the handclap-trigger detection unit 103. The selection unit 104 selects the selected trigger detection unit based on signals from the sound sensor 210, the distance sensor 211 and the light sensor 212. The selection unit 104 can select more than one trigger detection unit as the selected trigger detection units.

Here, the sound sensor 210 measures a sound volume of the usage environment of the television. It can measure the sound volume of both the sound obtained by the microphone 208 and the sound outputted through a loudspeaker of the television. The sound sensor 210 can obtain the sound as a digital signal, and the selection unit 104 can calculate sound volume (such as power) of the digital signal instead of the sound sensor 210. In this case, the sound sensor 210 can be replaced by the microphone 208.

The distance sensor 211 measures a distance from the television to the user. It can be replaced by a human detection sensor such as an infrared light sensor, which is able to detect whether the user exists within a predefined distance.

The light sensor 212 measures an amount of light in the usage environment of the television.

(The Voice-Trigger Detection Unit)

The voice-trigger detection unit 101 detects a voice-trigger from the sound obtained by the microphone 208.

A speech recognition apparatus with voice-trigger detects a predefined keyword utterance by a user as a start trigger, and starts to recognize the command utterance following the keyword utterance. For example, in the case that the predefined keyword is “hello”, the speech recognition apparatus detects the user utterance of “hello”, and outputs a bleep to notify the user that it is in a state to be able to recognize the command utterance. The speech recognition recognizes the command utterance such as “channel eight” following the bleep.

The voice-trigger detection unit 101 continues to recognize the sound obtained by the microphone 208 by utilizing recognition vocabulary including the predefined keyword utterance. It judges that the voice-trigger is detected when a recognition score obtained by the recognition process exceeds a threshold L. The threshold L is set to a value which can divide between the distribution of recognition scores of predefined keyword utterances and the distribution of recognition scores of other utterances.

The voice-trigger detection unit 101 can decrease recognition errors caused by environmental noises by narrowing down the recognition vocabulary only to the predefined keyword utterance.

However, detection performance of the voice-trigger detection unit 101 deteriorates in the environment that environmental noises or the sound of the television is too loud and the SNR (signal to noise ratio) of the keyword utterance becomes low.

(The Gesture-Trigger Detection Unit)

The gesture-trigger detection unit 102 detects a gesture-trigger from the image obtained by the camera 209.

A speech recognition apparatus with gesture-trigger detects predefined gesture by a user as a start trigger, and starts to recognize the command utterance following the gesture. For example, in the case that the predefined gesture is the action of waving a hand from side to side, the speech recognition apparatus detects user's action of waving his hand from side to side by utilizing an image recognition technique, and outputs a bleep to notify the user that it is in a state to be able to recognize command utterance. The speech recognition recognizes the command utterance such as “channel eight” following the bleep.

The gesture-trigger detection unit 102 detects the gesture-trigger by utilizing an image recognition technique. Therefore, there is a need for the user to gesture in the region where the camera 209 can take the image. Although the detection performance of the gesture-trigger detection unit 102 is not affected by environmental noises at all, it is affected by the lighting condition of the usage environment. Because of the image processing, moreover, it requires much more electric power compared to the other trigger detection units.

(The Handclap-Trigger Detection Unit)

The handclap-trigger detection unit 103 detects a handclap-trigger from the sound obtained by the microphone 208. Here, the handclaps detected by the handclap-trigger detection unit 103 are defined to handclaps two times in a row such as “clap, clap”.

A speech recognition apparatus with the handclap-trigger detects the handclaps as a start trigger, and outputs a bleep to notify the user that it is in a state to be able to recognize the command utterance. The speech recognition recognizes the command utterance following the bleep.

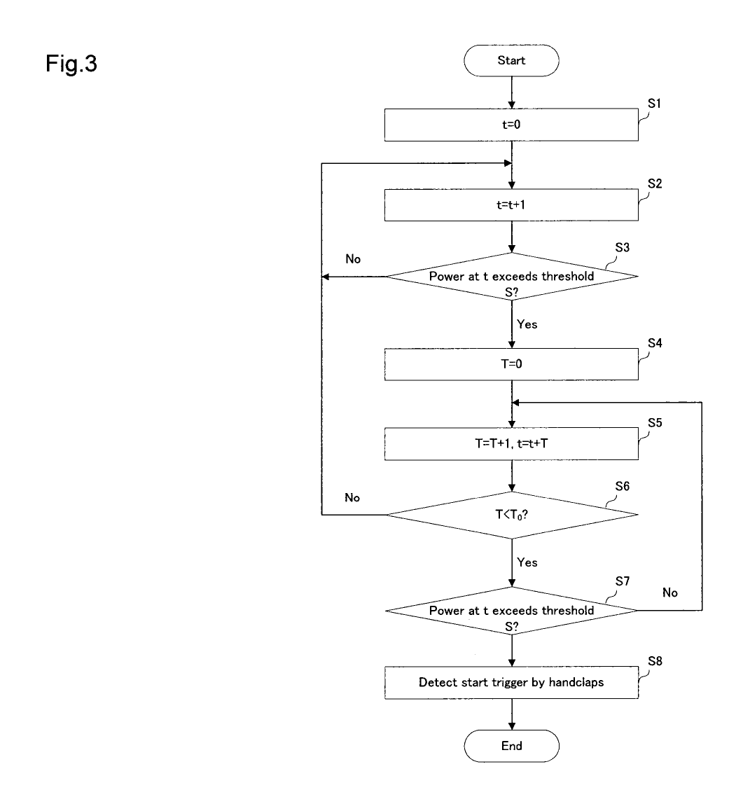

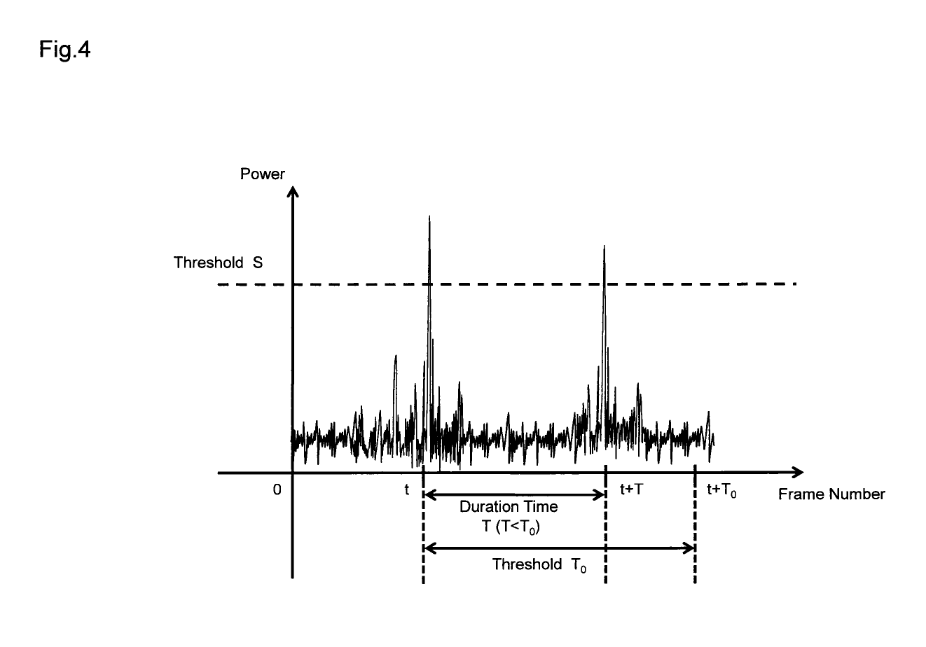

FIG. 3 is a flow chart of processing of the handclap-trigger detection unit 103. The handclap-trigger detection unit 103 detects a sound waveform whose power exceeds a predefined threshold S two times in a row during a predefined interval T₀, as shown in FIG. 4.

Here, the threshold T₀ is set to a value which covers the distribution of intervals of handclaps. The threshold S is set to a value which can divide between distributions of power with and without handclaps.

At S1 in FIG. 3, the microphone 208 starts to obtain a sound and a time parameter t is set to zero. The sound obtained by the microphone 208 is divided into frames each of which has a 25 msec length and an 8 msec interval. The t represents frame number. At S2, t is incremented by one. At S3, the power of the sound at t frame and compares the power to the threshold S is calculated. If the power exceeds the threshold 5, the process goes to S4. Otherwise, it goes to S2. At S4, a parameter T is set to zero. At S5, T is incremented by one, and t is incremented by T. At S6, T is compared to the threshold T₀. If T is less than T₀, the process goes to S7. Otherwise, it goes to S2. At S7, it calculates the power of the sound at t frame and compares the power to the threshold S. If the power exceeds the threshold 5, it goes to S8 and the handclap-trigger detection unit 103 judges that it detects a start-trigger by the handclaps. Otherwise, it goes to S2 and continues to process the flow.

The handclap-trigger detection unit 103 has robustness against environmental noises because the handclaps have unique sound features compared to environmental noises.

(The Recognition Unit)

The recognition unit 105 starts to recognize the command utterance by the user when the start trigger is detected by the selected trigger detection unit. Specifically, the sound obtained by the microphone 208 is input to unit 105 and unit 105 recognizes the command utterance included in the sound after the selected trigger detection unit detects the start trigger.

In addition, the recognition unit 105 can continually input and recognize the sound regardless of the detection of the start trigger. Unit 105 can output only a recognition result which is obtained after the detection of the start trigger.

(Flow Chart)

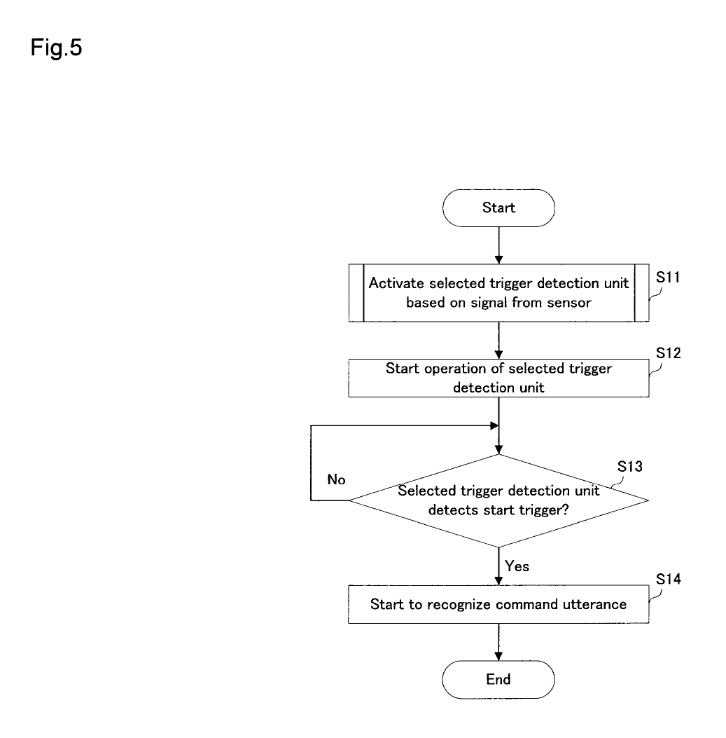

FIG. 5 is a flow chart of processing of the apparatus 100 for speech recognition according to this embodiment.

At S11, the selection unit 104 selects and activates a selected trigger detection unit. The selected trigger detection unit is selected from among the voice-trigger detection unit 101, the gesture-trigger detection unit 102 and the handclap-trigger detection unit 103. The selection unit 104 selects the selected trigger detection unit based on signals from the sound sensor 210, the distance sensor 211 and the light sensor 212.

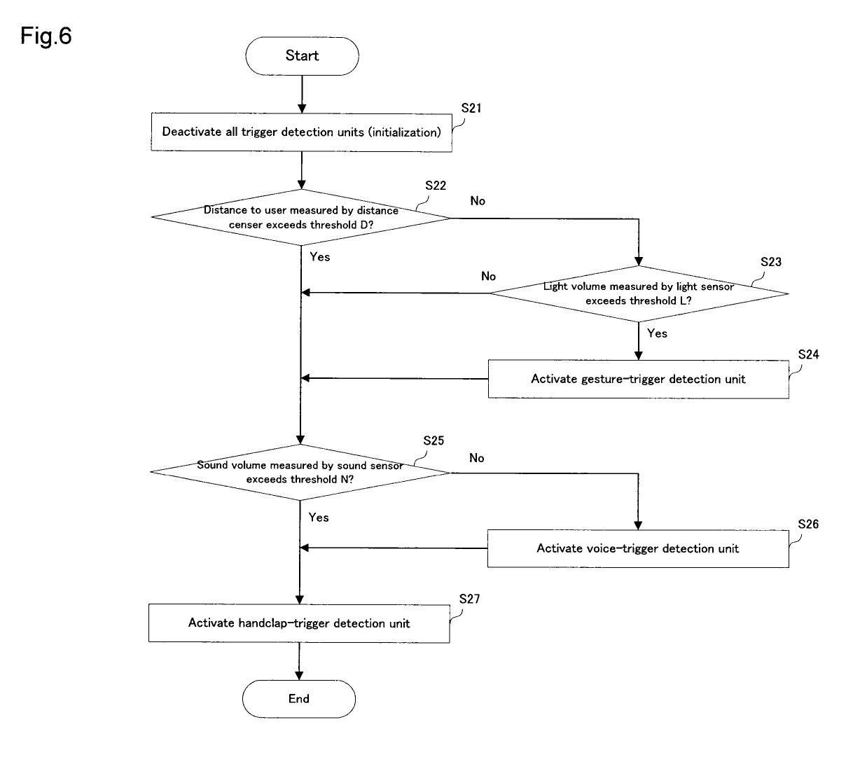

FIG. 6 is a flow chart of processing of S11 in FIG. 5. At S21, the selection unit 104 deactivates all of the trigger detection units (the voice-trigger detection unit 101, the gesture-trigger detection unit 102 and the handclap-trigger detection unit 103).

At S22, the selection unit 104 judges whether the distance from the television to the user measured by the distance sensor 211 exceeds a predefined threshold D. If the distance exceeds the threshold D, there is a possibility that image recognition performance by the gesture-trigger detection unit 102 is deteriorated because it is distant from the user. In this case, the selection unit 104 determines that the gesture-trigger detection unit 102 is not appropriate, and the process moves to S25. Otherwise, the process moves to S23.

The threshold D is experimentally determined based on the relationship between image recognition performance and the distance measured by the distance sensor 211.

At S23, the selection unit 104 judges whether the amount of light in the usage environment measured by the light sensor 212 exceeds a predefined threshold L. If the amount of light does not exceed the threshold L, there is a possibility that image recognition performance by the gesture-trigger detection unit 102 is deteriorated because the usage environment is too dark. In this case, the selection unit 104 determines that the gesture-trigger detection unit 102 is not appropriate to the usage environment, and the process moves to S25.

Otherwise, the process moves to S24, and activates the gesture-trigger detection unit 102 because both the distance and the light conditions are appropriate for recognizing the predefined gesture by the gesture-trigger detection unit 102.

The threshold L is experimentally determined based on the relationship between image recognition performance and the amount of light measured by the light sensor 212.

At S25, the selection unit 104 judges whether the sound volume in the usage environment measured by the sound sensor 210 exceeds a predefined threshold N. If the sound volume exceeds the threshold N, there is a possibility that detection performance of the keyword utterance by the voice-trigger detection unit 101 is deteriorated because the usage environment is noisy. In this case, the selection unit 104 determines that the voice-trigger detection unit 102 is not appropriate to the usage environment, and the process moves to S27.

Otherwise, the process moves to S26, and activates the voice-trigger detection unit 101 because the usage environment is not noisy and appropriate for recognizing the keyword utterance by the voice-trigger detection unit 102.

The threshold N is experimentally determined based on the relationship between detection performance of the keyword utterance and the sound volume measured by the sound sensor 210.

At S27, the selection unit 104 activates the handclap-trigger detection unit 103. In this embodiment, it always activates the handclap-trigger detection unit 103. This is because the handclap-trigger detection unit 103 can detect the handclap-trigger with high accuracy even when environmental noises are loud or the user is distant from the television.

The flow chart in FIG. 5 will now be explained. At S12, the apparatus 100 for speech recognition starts the operation of the selected trigger detection unit activated by S11.

At S13, apparatus 100 judges whether the start trigger is detected by the selected trigger detection unit. If the start trigger is detected, the process moves to S14. Otherwise, the process waits until the selected trigger detection unit detects the start trigger.

At S14, the recognition unit 105 starts to recognize the command utterance by the user.

(Effect)

In this way, the apparatus according to this embodiment selects an appropriate trigger detection unit under the usage environment of the television by utilizing a signal from one or more sensors embedded on the television. Accordingly, the apparatus can detect a start trigger with high accuracy, and results in improving recognition performance of the command utterance by the user.

(Variation 1)

The selection unit 104 can select one or more selected trigger detection units by utilizing only one of the sound sensor 210, the distance sensor 211 and the light sensor 212. For example, the selection unit 104 can determine whether to activate or deactivate the voice-trigger detection unit 101 by utilizing only the sound sensor 210 as shown in S25 of FIG. 6.

In addition, the selection unit 104 can determine whether to activate or deactivate the voice-trigger detection unit 101 by utilizing the distance sensor 211. In this case, unit 104 activates the voice-trigger detection unit 101 when the distance measured by the distance sensor 211 becomes equal to or less than the threshold D. This is because the sound volume of the user utterance becomes loud when the distance is small and the detection performance of the voice-trigger by the voice-trigger detection unit 101 becomes high enough.

In addition, the selection unit 104 can determine whether to activate or deactivate each trigger detection unit based on a control signal other than the sound sensor 210, the distance sensor 211 and the light sensor 212. For example, an electric power mode of the apparatus 100 can act as the control signal. For example, if the user selects power-saving mode, the selection unit 104 can deactivate the gesture-trigger detection unit 102 which requires much more electric power compared to the other trigger detection units.

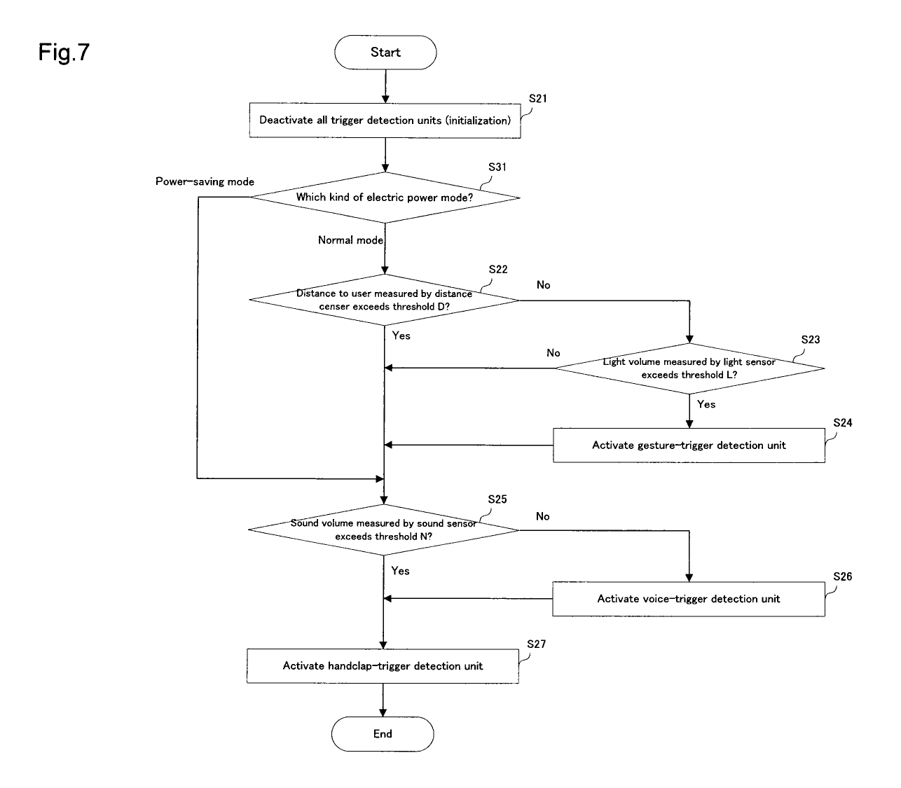

FIG. 7 is a flow chart of processing of the selection unit 104 which utilizes the electric power mode. At S31, selection unit 104 determines the electric power mode specified by the user. If the electric power mode is the normal mode, the process moves to S22, and the selection unit 104 determines whether to activate or deactivate each trigger detection unit including the gesture-trigger detection unit 102. If the electric power mode is the power-saving mode, the process moves to S 25, and the selection unit 104 deactivates the gesture-trigger detection unit 102 which requires much more electric power because of image processing.

(Variation 2)

The apparatus 100 for speech recognition can display the selected trigger detection unit to the user via the television screen.

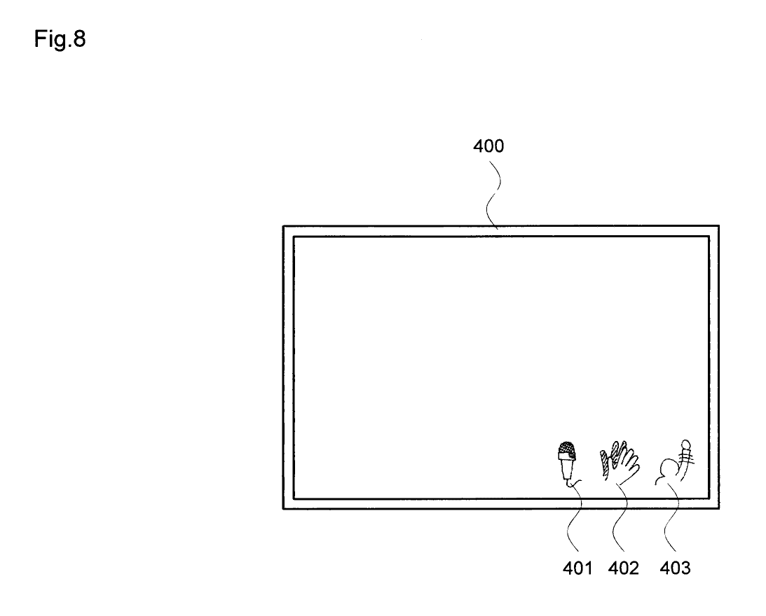

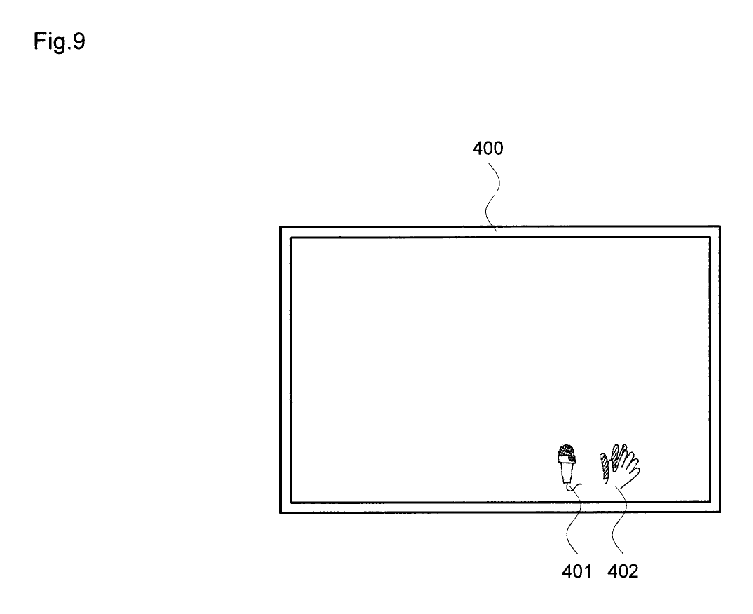

FIGS. 8 and 9 illustrate an image on television screen 400. For example, mark 401 in FIG. 8 represents that the voice-trigger detection unit 101 is activated by the selection unit 104. Marks 402 and 403 represent that the handclap-trigger detection unit 103 and the gesture-trigger detection unit 102 are activated, respectively. In FIG. 8, all of the trigger detection units are activated. Therefore, the user can give a start trigger to the television by keyword utterance, gesture or handclaps.

In FIG. 9, only the marks 401 and 402 are displayed on the television screen 400. Therefore, the user is not able to give a start trigger to the television by gesture.

In this way, the apparatus 100 according to this variation displays the selected trigger detection unit to the user. Accordingly, it helps the user select the appropriate action for giving a start trigger to the television.

The apparatus 100 can mount three LED illuminations and notify the selected trigger detection unit to the user by turning on the LED illumination corresponding to each trigger detection unit.

(Variation 3)

The command utterance includes a phrase such as “search sports programs”. The recognition unit 105 can be composed by utilizing an external server connected via the communication unit 205.

The trigger detection units are not limited to the voice-trigger detection unit 101, the gesture-trigger detection unit 102 and the handclap-trigger detection unit 103. The apparatus for speech recognition can utilize another trigger detection unit which detects another kind of start trigger. For example, the apparatus can detect

The apparatus for speech recognition can always activate the all trigger detection units and starts to recognize the command utterance only when the trigger detection unit selected by the selection unit 104 detects the start trigger.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms, furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An apparatus for speech recognition, comprising:
a plurality of trigger detection units, each of which is configured to detect a start trigger for recognizing a command utterance for controlling a device;
a selection unit, utilizing a signal from one or more sensors embedded on the device, configured to select a selected trigger detection unit among the trigger detection units, the selected trigger detection unit being appropriate to a usage environment of the device; and
a recognition unit configured to recognize the command utterance when the start trigger is detected by the selected trigger detection unit.

2. The apparatus according to claim 1, wherein
at least one of the sensors is a sound sensor that measures sound volume in the usage environment, at least one of the trigger detection units is a voice-trigger detection unit that detects a start trigger corresponding to a predefined keyword utterance by the user, and
the selection unit selects the voice-trigger detection unit as the selected trigger detection unit when the sound volume measured by the sound sensor is less than or equal to a predefined threshold.

3. The apparatus according to claim 1, wherein
at least one of the sensors is a light sensor that measures an amount of light in the usage environment, at least one of the trigger detection units is a gesture-trigger detection unit that detects a start trigger corresponding to a predefined gesture by the user, and
the selection unit selects the gesture-trigger detection unit as the selected trigger detection unit when the amount of light measured by the light sensor is more than a predefined threshold.

4. The apparatus according to claim 1, wherein
at least one of the sensors is a distance sensor that measures a distance from the device to the user, at least one of the trigger detection units is a gesture-trigger detection unit that detects a start trigger corresponding to a predefined gesture by the user, and
the selection unit selects the gesture-trigger detection unit as the selected trigger detection unit when the distance measured by the distance sensor is less than or equal to a predefined threshold.

5. The apparatus according to claim 1, wherein
at least one of the sensors is a distance sensor that measures a distance from the device to the user, at least one of the trigger detection units is a voice-trigger detection unit that detects a start trigger corresponding to a predefined keyword utterance by the user, and
the selection unit selects the voice-trigger detection unit as the selected trigger detection unit when the distance measured by the distance sensor is less than or equal to a predefined threshold.

6. The apparatus according to claim 1, wherein
the selection unit selects the selected trigger detection unit based on a control signal other than the signal from the one or more sensors.

7. The apparatus according to claim 1, wherein the device is connected to a television and is configured to display information on a screen of the television corresponding to at least one selected trigger detection unit.

8. A method for speech recognition, comprising:
selecting a selected trigger detection unit among a plurality of trigger detection units, each of which is configured to detect a start trigger for recognizing a command utterance for controlling a device, the selected trigger detection unit being appropriate to a usage environment of the device; and
recognizing the command utterance when the start trigger is detected by the selected trigger detection unit.

9. The method according to claim 8, comprising:
measuring a sound volume in the usage environment,
detecting a start trigger corresponding to a predefined keyword utterance by the user, and
selecting a voice-trigger detection unit as the selected trigger detection unit when the sound volume measured by the sound sensor is less than or equal to a predefined threshold.

10. The method according to claim 8, comprising:
measuring an amount of light in the usage environment;
detecting a start trigger corresponding to a predefined gesture by the user, and
selecting a gesture-trigger detection unit as the selected trigger detection unit when the amount of light measured by the light sensor is more than a predefined threshold.

11. The method according to claim 8, comprising:
measuring a distance from the device to the user;
detecting a start trigger corresponding to a predefined gesture by the user, and
selecting a gesture-trigger detection unit as the selected trigger detection unit when the distance measured by the distance sensor is less than or equal to a predefined threshold.

12. The method according to claim 8, comprising:
measuring a distance from the device to the user;
detecting a start trigger corresponding to a predefined keyword utterance by the user, and
selecting a voice-trigger detection unit as the selected trigger detection unit when the distance measured by the distance sensor is less than or equal to a predefined threshold.

13. The method according to claim 8, wherein the device includes one or more sensors for detecting a signal corresponding a condition of the usage environment, the method comprising:
selecting the selected trigger detection unit based on a control signal other than the signal from the one or more sensors.

14. The method according to claim 8, wherein the device is connected to a television, the method comprising:
displaying information on a screen of the television corresponding to at least one selected trigger detection unit.

15. A non-transitory computer readable medium having a program stored therein, when the program is executed by a computer causes the computer to perform a method comprising:
selecting a selected trigger detection unit among a plurality of trigger detection units, each of which is configured to detect a start trigger for recognizing a command utterance for controlling a device, the selected trigger detection unit being appropriate to a usage environment of the device; and
recognizing the command utterance when the start trigger is detected by the selected trigger detection unit.

16. The medium according to claim 15, wherein executing the program causes the computer to perform a method comprising:
receiving information of a sound volume in the usage environment,
detecting a start trigger corresponding to a predefined keyword utterance by the user, and
selecting a voice-trigger detection unit as the selected trigger detection unit when the sound volume measured by the sound sensor is less than or equal to a predefined threshold.

17. The medium according to claim 15, wherein executing the program causes the computer to perform a method comprising:
receiving information of an amount of light in the usage environment;
detecting a start trigger corresponding to a predefined gesture by the user, and
selecting a gesture-trigger detection unit as the selected trigger detection unit when the amount of light measured by the light sensor is more than a predefined threshold.

18. The medium according to claim 15, wherein executing the program causes the computer to perform a method comprising:
receiving information of a distance from the device to the user;
detecting a start trigger corresponding to a predefined gesture by the user, and
selecting a gesture-trigger detection unit as the selected trigger detection unit when the distance measured by the distance sensor is less than or equal to a predefined threshold.

19. The medium according to claim 15, wherein executing the program causes the computer to perform a method comprising:
receiving information of a distance from the device to the user;
detecting a start trigger corresponding to a predefined keyword utterance by the user, and
selecting a voice-trigger detection unit as the selected trigger detection unit when the distance measured by the distance sensor is less than or equal to a predefined threshold.

20. The medium according to claim 15, wherein executing the program causes the computer to perform a method comprising: receiving information from one or more sensors for detecting a signal corresponding a condition of the usage environment; and
selecting the selected trigger detection unit based on a control signal other than the signal from the one or more sensors.
